(19) United States
(12) Patent Application Publication
(10) Pub. No.: US 2017/0102486 A1
(43) Pub. Date: Apr. 13, 2017

(54) POLARIZING FILM AND LIQUID CRYSTAL DISPLAY DEVICE COMPRISING THE SAME

(71) Applicant: Wuhan China Star Optoelectronics Technology Co., Ltd, Wuhan, Hubei (CN)

(72) Inventors: Dandan Liu, Wuhan, Hubei (CN); De jiun Li, Wuhan, Hubei (CN); Tsung Ying Yang, Wuhan, Hubei (CN)

(73) Assignee: Wuhan China Star Optoelectronics Technology Co., Ltd, Wuhan, Hubei (CN)

(21) Appl. No.: 14/778,233

(22) PCT Filed: May 19, 2015
(86) PCT No.: PCT/CN2015/079322

§ 371 Date: Dec. 1, 2016

(30) Foreign Application Priority Data
May 11, 2015 (CN) 201510235562.9

(51) Int. Cl. G02B 5/02; G02B 1/118; G02B 5/30; G02F 1/1335

(52) U.S. Cl. CPC G02B 5/0221; G02F 1/133528; G02B 1/118; G02B 5/30; G02B 5/0242

(57) ABSTRACT

A polarizing film and a liquid crystal display device comprising the polarizing film are disclosed. The polarizing film comprises a base layer; an antiglare layer that is arranged on the base layer and is configured to have a first concave-convex structure; and a second concave-convex structure that is arranged on a surface of the first concave-convex structure, wherein a height of the second concave-convex structure from a bottom to a top thereof is configured to be less than a wavelength of visible light. In the polarizing film, the incident light can be scattered by the first concave-convex structure, so that mura can be shielded, the reflection of ambient light can be reduced, and the atomizing level can be improved.

### CROSS REFERENCE TO RELATED APPLICATION

The present application claims benefit of Chinese patent application CN 201510235562.9, entitled “Polarizing Film and Liquid Crystal Display Device Comprising the Same” and filed on May 11, 2015, the entirety of which is incorporated herein by reference.

### FIELD OF THE INVENTION

The present disclosure relates to the technical field of liquid crystal display device production, and particularly to a polarizing film and a liquid crystal display device comprising the polarizing film.

### BACKGROUND OF THE INVENTION

The liquid crystal display device has been used in more and more fields because of its advantages of low power consumption, small volume, light weight, super thinness, and so on. The liquid crystal display device is mainly composed of a polarizing film, a transparent conductive glass, and liquid crystal materials. An iodine based polarizing film is a typical polarizing film, and is widely used in various liquid crystal display devices at present. The iodine molecules which are embedded in a polyvinyl alcohol film can be oriented through stretching the polyvinyl alcohol film with a certain multiples, so that light with a polarization direction parallel to the stretching direction (i.e., an absorption axis) can be absorbed, while light with a polarization direction perpendicular to the absorption axis (i.e., a transmission axis) would not be substantially weakened. Therefore, after passing through the polarizing film, natural light with vibration in all directions can be changed into polarized light with a vibration direction thereof parallel to the transmission axis. Then, liquid crystal molecules with torsion property can be add between two polarizing films with transmission axes thereof perpendicular to each other, so that the transmission of the light can be controlled and thus images can be displayed.

However, when an image is presented on a display screen with low brightness, such as a liquid crystal display device, under ambient light with high brightness, the image cannot be recognized easily. Moreover, eyes would be seriously hurt after long time watching. Meanwhile, when a person watches the display device under ambient light, the definition of the display panel would be affected since an image would be left on the display panel due to the reflection of the external light. Therefore, the polarizing film needs to be treated suitably, so that brightness of reflected image of an ambient light source can be reduced, the un-comfortableness brought about after long time watching can be weakened, and a person can watch the display device for a long time.

There are many methods in the prior art for preventing ambient light. For example, a surface of a film is generally mechanically ground or corroded in a selective manner by a corrodent such as hydrofluoric acid, so that the surface becomes rough and glare can be prevented. However, according to the method, serious pollution would be brought about to the environment, and the film after treatment cannot be recycled and reused. For another example, a composite plating layer can be formed by materials with different refractive indexes, and the reflection of incident light on the surface can be reduced by an interference effect of the composite layer. However, the manufacturing cost of the composite layer is high. In addition, mura usually occurs, and thus a display effect of the display panel is not satisfactory.

### SUMMARY OF THE INVENTION

With respect to the aforesaid technical problem in the prior art, the present disclosure provides a polarizing film and a liquid crystal display device comprising the polarizing film. In the polarizing film according to the present disclosure, the incident light can be scattered by the first concave-convex structure, so that mura can be shielded and a display effect of the liquid crystal display device can be improved. Meanwhile, the reflection of incident light can be reduced by the polarizing film, and thus the atomizing level thereof can be improved. In addition, the polarizing film has a simple structure, and the manufacturing cost thereof is low.

According to a first aspect, the present disclosure provides a polarizing film, which comprises:
a base layer;
an antiglare layer that is arranged on the base layer, wherein the antiglare layer is configured to have a first concave-convex structure; and
a second concave-convex structure that is arranged on a surface of the first concave-convex structure, wherein a height of the second concave-convex structure from a bottom to a top thereof is configured to be less than a wavelength of visible light.

In the polarizing film according to the present disclosure, the antiglare layer is configured to have the first concave-convex structure, so that glare can be prevented. That is, the incident light can be scattered. At the same time, mura can be shielded by the first concave-convex structure. In addition, the polarizing film further comprises the second concave-convex structure, i.e., a moth-eye structure. With the moth-eye structure, the refractive index can be made to change continuously at an interface of two mediums, so that the reflection of light at the interface of two mediums with different refractive indexes can be prevented. The reflection of light on a surface of the polarizing film can be prevented by the second concave-convex structure to a large extent, so that the declining of picture contrast of an image can be avoided when the image is presented under ambient light with high brightness. Therefore, glare can be prevented and mura can be shielded by the polarizing film with this structure, and the display effect of the liquid crystal display device can be improved.

According to one embodiment, light scattering particles are arranged in the antiglare layer. The incident light can be scattered by the light scattering particles, so that the scattering effect of the polarizing film can be further improved. In this case, the mura shielding function of the polarizing film and the display effect thereof can both be improved. If a size of each of the light scattering particles is less than 0.2 μm, a scattering effect would not be achieved sufficiently. However, if the size of each of the light scattering particles is larger than 0.6 μm, the scattering angle would become small even if the scattering level (i.e., the atomizing level) thereof is high. As a result, an effective scattering would not be achieved, and the light extraction efficiency would be reduced. The light extraction efficiency would change to a relatively large extent with the changing of wavelength, and the color tone would change easily. Therefore, preferably, the size of each of the light scattering particles ranges from 0.2 μm to 0.6 μm. That is, the size of each of the light scattering particles is larger than or equal to 0.2 μm and less than or equal to 0.6 μm at the same time.

According to one embodiment, a height of the second concave-convex structure ranges from 150 nm to 250 nm. In addition, a distance between two adjacent concave portions of the second concave-convex structure ranges from 80 nm to 180 nm. With this arrangement, the light reflection on the surface of the polarizing film can be fully reduced, and a mechanical strength of the second concave-convex structure can be ensured.

According to one embodiment, a height of the first concave-convex structure ranges from 1 μm to 2 μm, and a distance between two adjacent concave portions of the first concave-convex structure ranges from 0.8 μm to 1.2 μm. The antiglare effect of the polarizing film can be fully guaranteed with this arrangement, so that the display effect of the liquid crystal display device can be improved.

According to one embodiment, the first concave-convex structure and the second concave-convex structure are formed at the same time through nano-imprinting technology. With this arrangement, the whole structure of the polarizing film can be simplified, and the manufacturing difficulty as well as the manufacturing cost thereof can both be reduced.

According to one embodiment, the polarizing film further comprises a resin layer that covers at least part of the second concave-convex structure. Preferably, a thickness of the resin layer that covers the concave portions of the second concave-convex structure is larger than a thickness of the resin layer that covers convex portions of the second concave-convex structure. During practical production, the second concave-convex structure is generally formed through nano-imprinting technology, and the structure thereof is only determined by the mould. When the second concave-convex structure with a different structure needs to be formed according to a different design, a new mould should be provided. As a result, the manufacturing cost thereof would be increased. The height of the second concave-convex structure can be regulated through the resin layer arranged therein, so that the applicable scope of the mould can be improved and the manufacturing cost thereof can be reduced.

According to a second aspect, the present disclosure provides a liquid crystal display device, which comprises the aforesaid polarizing film.

Compared with the prior art, the following advantages can be brought about according to the present disclosure. The reflection of the ambient light can be effectively reduced by the polarizing film, so that the antiglare function can be realized, and the display performance of the liquid crystal display device can be improved.

### BRIEF DESCRIPTION OF THE DRAWINGS

The preferred embodiments of the present disclosure will be illustrated in detail hereinafter with reference to the drawings. In the drawings:

FIG. 1 is a sectional view of a polarizing film according to a first embodiment of the present disclosure;

FIG. 2 is a sectional view of a polarizing film according to a second embodiment of the present disclosure;

FIG. 3 is an enlarged diagram of area A of FIG. 1 or FIG. 2 according to a first embodiment;

FIG. 4 is an enlarged diagram of area A of FIG. 1 or FIG. 2 according to a second embodiment; and

FIG. 5 is an enlarged diagram of area A of FIG. 1 or FIG. 2 according to a third embodiment.

In the drawings, a same component is represented by a same reference sign. The drawings are not drawn according to actual scale.

### DETAILED DESCRIPTION OF THE EMBODIMENTS

The present disclosure will be further illustrated hereinafter with reference to the drawings.

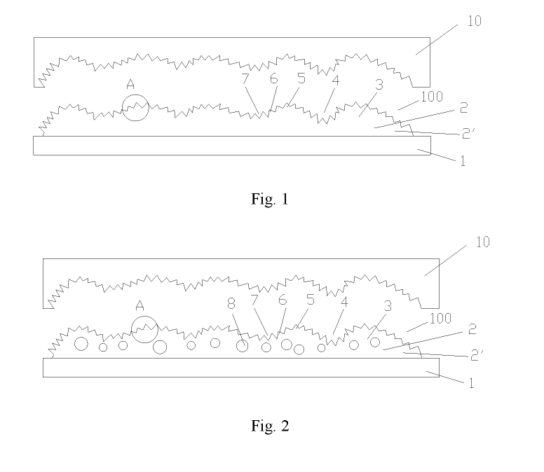

FIG. 1 schematically shows a structure of a polarizing film 100. As shown in FIG. 1, the polarizing film 100 comprises a base layer 1 and an antiglare layer 2, wherein the antiglare layer 2 is arranged on a surface of the base layer 1. The antiglare layer 2 is configured to have a first concave-convex structure 2′, which comprises a first convex portion 3 and a first concave portion 4. A second concave-convex structure 5 comprising a second convex portion 6 and a second concave portion 7 is arranged on a surface of the first concave-convex structure 2′. A height of the second concave-convex structure 5 from a bottom to a top thereof is configured to be less than a wavelength of visible light.

The antiglare layer 2 comprises micro concave-convex structures that are formed on an upper surface of the base layer 1, whereby ambient light can be prevented based on the light scattering principle. In this case, the polarizing film can play the role of antiglare, and mura can be shielded to some extent. In addition, the polarizing film 100 further comprises the second concave-convex structure 5, thus forming a moth-eye structure. With the moth-eye structure, the refractive index can be made to change continuously at an interface of two mediums, so that the reflection of the light at the interface of two mediums with different refractive indexes can be prevented. The reflection of light on a surface of the polarizing film 100 can be prevent by the second concave-convex structure 5 to a large extent, so that the declining of picture contrast of an image can be avoided when the image is presented under ambient light with high brightness. Therefore, glare can be prevented and mura can be shielded by the polarizing film 100 with this structure. In addition, the reflection of ambient light can be reduced, the image in a dark state can become more satisfactory, and a higher picture contrast can be achieved. In a word, the display effect of the liquid crystal display device can be improved.

According to the present disclosure, in order to further improve the antiglare effect, light scattering particles 8 are arranged in the antiglare layer 2, as shown in FIG. 2. The light scattering particles 8 can be distributed in the antiglare layer 2 irregularly within a certain range, so that ambient light can be scattered in a uniform manner. The incident light can be scattered by the light scattering particles 8, so that the light scattering effect of the polarizing film 100 and the mura shielding function thereof can both be improved. If a size of each of the light scattering particles 8 is less than 0.2 μm, a scattering effect would not be achieved sufficiently. However, if the size of each of the light scattering particles 8 is larger than 0.6 μm, the scattering angle would become small even if the scattering level (i.e., the atomizing level) thereof is high. As a result, an effective scattering would not be achieved, and the light extraction efficiency would be reduced. The light extraction efficiency would change to a relatively large extent with the changing of the wavelength, and the color tone would change easily.

Therefore, preferably, the size of each of the light scattering particles 8 ranges from 0.2 μm to 0.6 μm.

According to one embodiment, a height of the first concave-convex structure 2′ ranges from 1 μm to 2 μm, and a distance between two adjacent concave portions (the first concave portions 4) of the first concave-convex structure ranges from 0.8 μm to 1.2 μm. The antiglare effect of the polarizing film 100 can be fully guaranteed with this arrangement, so that the display effect of the liquid crystal display device can be improved.

According to one embodiment of the present disclosure, a height of the second concave-convex structure 5 ranges from 150 nm to 250 nm, and a distance between two adjacent concave portions (the second concave portions 7) of the second concave-convex structure 5 ranges from 80 nm to 180 nm. With this arrangement, the light reflection on the surface of the polarizing film can be fully reduced, and a mechanical strength of the second concave-convex structure 5 can be ensured.

The first concave-convex structure 2′ and the second concave-convex structure 5 can be formed at the same time through nano-imprinting technology. That is, during the manufacturing of the first concave-convex structure 2′ and the second concave-convex structure 5, the manufacturing material is first filled into a mould 10, and then the mould 10 can be combined with the base layer 1 closely so that the material in the mould 10 can be transferred to the base layer 1. In this manner, the dense micro concave-convex structures can be formed on the surface of the base layer 1, and the concave-convex structures can be solidified under ultraviolet irradiation. According to the manufacturing method, the convex portions can be distributed on the surface of the polarizing film 100 in a uniform manner, and no volatile solvent is necessary. In addition, according to the manufacturing method, not only the antiglare function and the definition of the polarizing film 100 can be guaranteed, but also large-scale production of the polarizing film 100 can be realized in a normalized and reliable manner. Moreover, the amount of volatile solvent used during the manufacturing can be greatly reduced, and thus a clean production procedure can be realized. That is, the manufacturing cost can be reduced, the resource consumption can be saved, and air pollution can be avoided. Preferably, the first concave-convex structure 2′ and the second concave-convex structure 5 are made of light solidification resin. The light solidification resin can be one selected from a group consisting of epoxy acrylate and polyurethane acrylate.

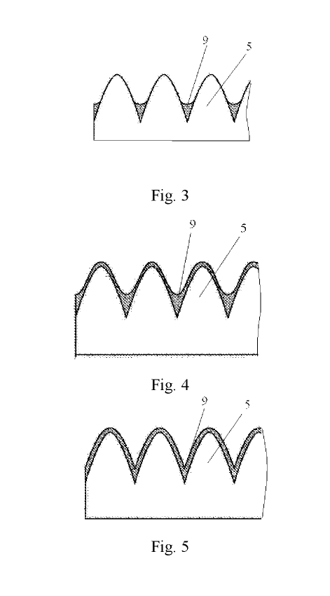

As shown in FIG. 3, a resin layer 9 is arranged on the second concave portions 7 of the second concave-convex structure 5, so as to regulate the height of the second concave-convex structure 5. In this case, the height of the second concave-convex structure 5 is a distance between the resin layer 9 and a top of the second convex portion 6.

Of course, the resin layer 9 can also be arranged on the whole surface of the second concave-convex structure 5 instead of only on the second concave portions 7, as shown in FIG. 4. Preferably, in order to realize that the height of the second concave-convex structure 5 after the resin layer 9 is arranged (i.e., a distance between the resin layer 9 on the second concave portion 7 to the resin layer 9 on the second convex portion 6) is less than the height of the second concave-convex structure 5 when the resin layer 9 is not arranged, a thickness of the resin layer 9 that covers the second concave portions 7 is larger than a thickness of the resin layer 9 that covers the second convex portions 6. In this case, the resin layer 9 on the second convex portion 6 can play the role of protecting the second concave-convex structure 5. In particular, when the resin layer contains fluorine, the friction coefficient of the second concave-convex structure 5 can be reduced, and thus the smoothness thereof becomes better.

Of course, the thickness of the resin layer 9 that covers the second concave portions 7 can be equal to the thickness of the resin layer 9 that covers the second convex portions 6, as shown in FIG. 5. In this case, the resin layer 9 can no longer regulate the height of the second concave-convex structure 5.

Compared with the case that no resin layer 9 is arranged, the height of the second concave-convex structure 5 can be reduced when the resin layer 9 is arranged. During practical production, the second concave-convex structure 5 is generally formed through nano-imprinting technology, and the structure thereof is solely determined by the mould. When the second concave-convex structure 5 with a different structure needs to be formed according to a different design, a new mould should be provided. As a result, the manufacturing cost thereof would be increased. The height of the second concave-convex structure 5 can be regulated through the resin layer 9 arranged therein, so that the applicable scope of the mould can be improved and the manufacturing cost thereof can be reduced.

The resin layer 9 can be formed through spin coating, die coating, spray coating, or the like. The resin layer 9 is preferably made of resin containing fluorine atom. When resin containing fluoride is used, the refractive index of the second concave-convex structure 5 can be reduced and the smoothness thereof becomes better. In this case, the increasing of reflectivity can be prevented, and the friction endurance thereof can be improved. In addition, fluoride can reduce the surface energy of the second concave-convex structure 5, so that the resin layer 9 can be prevented from being affixed to the mould 10. In addition, the dirt in the second concave-convex structure 5 can be cleared up easily. Therefore, with this arrangement, the cleanness and dirt-proofness of the polarizing film 100 can both be improved.

Preferably, the base layer 1 can be made of one selected from a group consisting of Tri-cellulose Acetate (TCA), PolymethylMethacrylate (PMMA), polyethylene terephthalate (PET), and COP.

The present disclosure further provides a liquid crystal display device (not shown in the Figs) which comprises the aforesaid polarizing film 100. The liquid crystal display device further comprises other structures and components, which are well known to those skilled in the art. The details of which are no longer repeated here.

The preferred embodiments of the present disclosure are stated hereinabove, but the protection scope of the present disclosure is not limited by this. Any changes or substitutes readily conceivable for those skilled in the art within the technical scope disclosed herein shall be covered by the protection scope of the present disclosure. Therefore, the protection scope of the present disclosure shall be determined by the scope as defined in the claims.

1. A polarizing film, comprising:
a base layer;
an antiglare layer that is arranged on the base layer, wherein the antiglare layer is configured to have a first concave-convex structure; and
a second concave-convex structure that is arranged on a surface of the first concave-convex structure, wherein a height of the second concave-convex structure from a bottom to a top thereof is configured to be less than a wavelength of visible light.

2. The polarizing film according to claim 1, wherein light scattering particles are arranged in the antiglare layer.

3. The polarizing film according to claim 2, wherein a size of each of the light scattering particles ranges from 0.2 μm to 0.6 μm.

4. The polarizing film according to claim 1, wherein a height of the second concave-convex structure ranges from 150 nm to 250 nm.

5. The polarizing film according to claim 2, wherein a height of the second concave-convex structure ranges from 150 nm to 250 nm.

6. The polarizing film according to claim 4, wherein a distance between two adjacent concave portions of the second concave-convex structure ranges from 80 nm to 180 nm.

7. The polarizing film according to claim 5, wherein a distance between two adjacent concave portions of the second concave-convex structure ranges from 80 nm to 180 nm.

8. The polarizing film according to claim 4, wherein a height of the first concave-convex structure ranges from 1 μm to 2 μm; and
wherein a distance between two adjacent concave portions of the first concave-convex structure ranges from 0.8 μm to 1.2 μm.

9. The polarizing film according to claim 5, wherein a height of the first concave-convex structure ranges from 1 μm to 2 μm; and
wherein a distance between two adjacent concave portions of the first concave-convex structure ranges from 0.8 μm to 1.2 μm.

10. The polarizing film according to claim 1, wherein the first concave-convex structure and the second concave-convex structure are formed at the same time through nano-imprinting technology.

11. The polarizing film according to claim 2, wherein the first concave-convex structure and the second concave-convex structure are formed at the same time through nano-imprinting technology.

12. The polarizing film according to claim 1, further comprising a resin layer that covers at least part of the second concave-convex structure.

13. The polarizing film according to claim 2, further comprising a resin layer that covers at least part of the second concave-convex structure.

14. The polarizing film according to claim 12, wherein a thickness of the resin layer that covers the concave portions of the second concave-convex structure is larger than a thickness of the resin layer that covers convex portions of the second concave-convex structure.

15. The polarizing film according to claim 13, wherein a thickness of the resin layer that covers the concave portions of the second concave-convex structure is larger than a thickness of the resin layer that covers convex portions of the second concave-convex structure.

16. A liquid crystal display device, comprising a polarizing film, which comprises:
a base layer;
an antiglare layer that is arranged on the base layer, wherein the antiglare layer is configured to have a first concave-convex structure; and
a second concave-convex structure that is arranged on a surface of the first concave-convex structure, wherein a height of the second concave-convex structure from a bottom to a top thereof is configured to be less than a wavelength of visible light.

17. The liquid crystal display device according to claim 16, wherein light scattering particles are arranged in the antiglare layer.

18. The liquid crystal display device according to claim 16, wherein a height of the second concave-convex structure ranges from 150 nm to 250 nm.

19. The liquid crystal display device according to claim 18, wherein a distance between two adjacent concave portions of the second concave-convex structure ranges from 80 nm to 180 nm.

20. The liquid crystal display device according to claim 16, further comprising a resin layer that covers at least part of the second concave-convex structure.
